(19) United States
(12) Patent Application Publication
(10) Pub. No.: US 2025/0309935 A1
(43) Pub. Date: Oct. 2, 2025

(54) MANAGING TRANSCEIVER CAPABILITIES FOR NETWORK DEVICES

(71) Applicant: Arista Networks, Inc., Santa Clara, CA (US)

(72) Inventors: Radu Handolescu, San Jose, CA (US); Aditya Bhiday, Sunnyvale, CA (US)

(21) Appl. No.: 18/622,240

(22) Filed: Mar. 29, 2024

(51) Int. Cl. H04B 1/40

(52) U.S. Cl. CPC H04B 1/40

(57) ABSTRACT

Some embodiments provide a method for managing transceiver capabilities for a network device. The method detects that a transceiver is inserted into the network device. In response to the detection, a set of data is read from a memory of the transceiver. Based on the set of data, the method determines whether an override profile from a set of override profiles matches the transceiver. Each override profile in the set of override profiles specifies a set of capabilities to be used for a particular transceiver. Upon determining that the override profile from the set of override profiles matches the transceiver, the set of capabilities specified in the override profile are used for the transceiver.

### BACKGROUND

Network device transceivers are electronic devices used in networking equipment to communicate (e.g., transmit, receive, etc.) data over networks. They may be used in a number of different types of networking devices, such as switches, routers, network interface cards (NICs), etc., for example. There are various different types of network device transceivers. Examples of types of transceivers include Ethernet transceivers, fiber optic transceivers, wireless transceivers, copper transceivers, etc. In general, network device transceivers are interchangeable and can be hot-swappable. This way, network administrators may easily replace or upgrade them without powering down the network device.

The following detailed description and accompanying drawings provide a better understanding of the nature and advantages of various embodiments of the present disclosure.

### BRIEF DESCRIPTION OF THE DRAWINGS

FIG. 1 illustrates a network device for managing transceiver capabilities according to some embodiments.

FIG. 2 illustrates the network device illustrated in FIG. 1 preparing override profiles according to some embodiments.

FIG. 3 illustrates the network device illustrated in FIG. 1 determining capabilities for an inserted transceiver according to some embodiments.

FIG. 4 illustrates the network device illustrated in FIG. 1 processing a new user-defined override profile according to some embodiments.

FIG. 5 illustrates a process for determining capabilities for an inserted transceiver according to some embodiments.

FIG. 6 illustrates an example network device according to some embodiments.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for managing transceiver capabilities for network devices. The network device is configured to manage override profiles for overriding the behavior of transceivers. In some embodiments, an override profile specifies a set of capabilities to use for a transceiver. Each override profile is associated with a set of matching criteria for determining whether a transceiver matches the override profile. When a transceiver is inserted into a transceiver port of the network device, the network device reads data from the memory of the transceiver. The data includes information associated with the transceiver (e.g., vendor information, firmware information, etc.) as well as a set of advertised capabilities for the transceiver. Based on the data and the sets of matching criteria of the override profiles, the network device determines whether an override profile matches the transceiver. If a match is found, the network device uses the set of capabilities specified in the override profile for the transceiver. Otherwise, the network device uses the set of advertised capabilities for the transceiver.

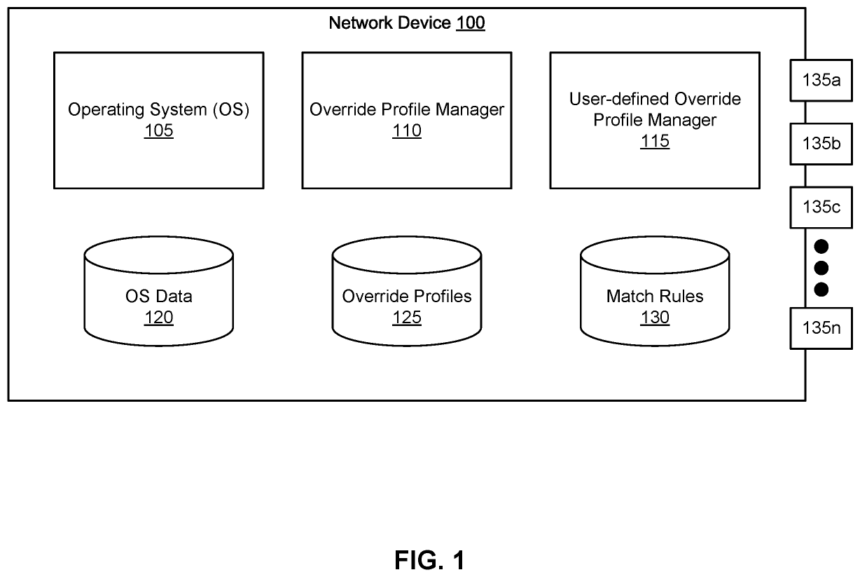

FIG. 1 illustrates a network device 100 managing transceiver capabilities according to some embodiments. As shown, network device 100 includes operating system (OS) 105, override profile manager 110, user-defined override profile manager 115, OS data storage 120, override profiles storage 125, match rules storage 130, and transceiver ports 135a-n. OS data storage 120 is configured to store data associated with the OS of network device 100. For instance, OS data storage 120 can store operating system files used for operating network device 100, such as device drivers (e.g., device drivers for controlling transceiver ports 135a-n), system libraries, executable programs, etc., for example. OS data storage 120 may also store files that contain predefined override profiles (also referred to as default override profiles) and match rules associated with the predefined override profiles. In some instances, these files are prepackaged files provided with OS 105. In some embodiments, OS data storage 120 is a non-volatile storage. Override profiles storage 125 stores override profiles. As mentioned above, in some embodiments, an override profile specifies a set of capabilities to use for a transceiver.

Match rules storage 130 is configured to store match rules for matching override profiles with transceivers. In some embodiments, a match rule specifies a set of matching criteria and an override profile to use when the set of matching criteria are satisfied. Many types of matching criteria can be specified in match rules. One type of matching criteria is vendor information. Examples of vendor information include vendor name, transceiver part number, transceiver serial number, transceiver revision number, etc. Another type of matching criteria is firmware information. Examples of firmware information include firmware version number, etc. One of ordinary skill in the art would understand that a set of matching criteria specified in a match rule may include one or more of any number of different matching criteria. For instance, a set of matching criteria can specify a vendor name, a transceiver part number, and a range of transceiver serial numbers. In some embodiments, a set of matching criteria specified in a matching rule includes at least one piece of vendor information.

OS 105 is software executable by a set of processors (not shown in FIG. 1) of network device 100 that is responsible for handling various operations of network device 100. In some embodiments, OS 105 is configured to facilitate and manage network resources within a computer network. For example, OS 105 may utilize a set of drivers to control the operation of transceivers communicatively coupled to transceiver ports 135a-n. For each transceiver that is inserted into a transceiver port 135 such that the transceiver is communicatively coupled to the network device 100, OS 105 can determine a set of capabilities to use for the transceiver. OS 105 controls how the transceiver operates based on the set of capabilities.

In some embodiments, the set of capabilities that OS 105 uses to control how a transceiver operates can include one or more of a feature, function, or parameter that is common across most/all transceivers; a feature, function, or parameter that is specific to a particular standard (e.g., Common Management Interface Specification (CMIS), small form factor (SFF)-8636, SFF-8472, etc.); and a feature, function, or parameter that is not advertised by the transceiver and/or specified in a particular standard. Examples of capabilities that are common across most/all transceivers may be signal integrity settings that can be changed such as receive (RX) output amplitude, transmit (TX) input equalization, RX output pre-emphasis, RX output post-emphasis, etc. Examples of capabilities that are specific to a particular standard can be a command data block (CDB) feature for a transceiver that conforms to the CMIS standard, etc.

A feature, function, or parameter that is not advertised by a transceiver and/or specified in a particular standard may be a feature, function, or parameter for improving or enhancing the behavior of how OS 105 handles a transceiver. In some embodiments, such a feature, function, or parameter can control the behavior of one or more drivers in OS 105 that controls how the transceiver operates. Examples of these features, functions, or parameters include inserting a delaying of a defined amount of time after every write operation performed on the memory of the transceiver, writing certain data (e.g., a password) to the transceiver before executing any firmware upgrade commands on the transceiver, ignoring result codes for certain operations performed on the transceiver (e.g., ignoring a failed or no status result code when performing a firmware upgrade on the transceiver), reading certain parameters (e.g., temperature, voltage, etc.) associated with the transceiver when performing a firmware upgrade on the transceiver, etc.

When a transceiver is inserted into a transceiver port 135, OS 105 determines a set of capabilities to use for the transceiver. OS 105 first reads data from the memory of the transceiver. The data that network device 100 reads from the memory of the transceiver includes information associated with the transceiver (e.g., vendor information, firmware information, etc.) and a set of advertised capabilities for the transceiver. Next, OS 105 determines a set of capabilities to use for the transceiver based on the data read from the memory of the transceiver. Specifically, OS 105 sends override profile manager 110 a request for a set of override capabilities for the transceiver and the information associated with the transceiver that was read from the memory of the transceiver. In response, OS 105 can receive from override profile manager 110 a message indicating either a set of override capabilities to use for the transceiver or no override capabilities exist for the transceiver. In instances where the message indicates a set of override capabilities to use for the transceiver, OS 105 uses the set of override capabilities for the transceiver. In instances where the message indicates no override capabilities exist for the transceiver, OS 105 uses the advertised set of capabilities, which was read from the memory of the transceiver, for the transceiver.

OS 105 is also involved in the management of user-defined override profiles. For example, network device 100 can receive user-defined override profiles and match rules from users. One of ordinary skill in the art will appreciate that network device 100 may receive user-defined override profiles and match rules from any number of different ways. For instance, network device 100 can receive user-defined override profiles and match rules through a command line interface (CLI) provided by network device 100, from a network management platform, from a network management application, from a network management service, etc. When network device 100 receives a user-defined override profile and a match rule associated with the user-defined override profile, OS 105 persists them in OS data storage 120. OS 105 also sends the newly received user-defined override profile and associated match rule to user-defined override profile manager 115. Once OS 105 receives from override profile manager 110 a notification that override profiles storage 125 and match rules storage 130 have been updated with the newly added user-defined override profile and associated match rule, OS 105 checks each transceiver attached (i.e., communicatively coupled) to network device 100 to see if the transceiver matches the set of matching criteria of the match rule. For each attached transceiver, OS 105 sends override profile manager 110 a reference to the match rule, information associated with the transceiver, and a request to check whether the transceiver satisfies the match rule. In response to each request, OS 105 receives from override profile manager 110 a message indicating either a set of override capabilities to use for the transceiver (i.e., the set of capabilities specified in the new user-defined override profile) or the transceiver does not satisfy the match rule. In instances where OS 105 receives a message indicating a set of override capabilities to use for the transceiver, OS 105 starts using the set of override capabilities for the transceiver. In instances where OS 105 receives a message indicating the transceiver does not satisfy the match rule, OS 105 continues using the existing set of capabilities for the transceiver.

In some cases, during the boot up of network device 100, OS 105 may retrieve the user-defined override profiles and the associated match rules from OS data storage 120 and send them to user-defined override profile manager 115. In other cases, network device 100 can receive (e.g., from a user) a set of instructions to delete a user-defined override profile and associated match rule. In response to the set of instructions, OS 105 deletes them from OS data storage 120. Then, OS 105 sends user-defined override profile manager 115 a notification indicating that the user-defined override profile and associated match rule have been deleted. In yet other cases, network device 100 may receive (e.g., from a user) requests to modify existing user-defined override profiles and/or match rules associated user-defined override profiles. In response to such a request, OS 105 sends the request to user-defined override profile manager 115 for processing.

Override profile manager 110 handles the management of override profiles for network device 100. For instance, when network device 100 boots up, override profile manager 110 is responsible for loading override profiles into override profiles storage 125. Specifically, override profile manager 110 accesses OS data storage 120 and retrieves predefined override profiles and match rules associated with the predefined override profiles from the files that contain them. Next, override profile manager 110 can receive user-defined override profiles and match rules associated with the user-defined override profiles from user-defined override profile manager 115. Then, override profile manager 110 stores the predefined override profiles and the user-defined override profiles in override profiles storage 125. Override profile manager 110 also stores the match rules associated with the predefined override profiles and the match rules associated with the user-defined override profiles in match rules storage 130.

In some cases, override profile manager 110 may receive from user-defined override profile manager 115 a user-defined override profile and a match rule associated with the user-defined override profile that are newly received by network device 100. In response to receiving this newly received data, override profile manager 110 stores the user-defined override profile in override profiles storage 125, stores the associated match rule in match rules storage 130, and sends OS 105 a notification that override profiles storage 125 and match rules storage 130 have been updated with the newly added user-defined override profile and associated match rule. In other cases, override profile manager 110 may receive from user-defined override profile manager 115 a notification indicating that a user-defined override profile and associated match rule have been deleted. In response, override profile manager 110 deletes the user-defined override profile from override profiles storage 125 and deletes the associated match rule from match rules storage 130.

In addition, override profile manager 110 handles requests for override capabilities to use for a transceiver. For example, override profile manager 110 may receive from OS 105 a request for a set of override capabilities for a transceiver along with data associated with the transceiver. To determine a set of override capabilities to use for the transceiver, override profile manager 110 accesses match rules storage 130 and determines, based on the information associated with the transceiver, whether the set of matching criteria specified in a match rule are satisfied. In some embodiments, override profile manager 110 determines whether the set of matching criteria specified in a match rule are satisfied by iterating through each of the match rules to check whether the set of matching criteria of the match rule are satisfied. In other embodiments, match rules storage 130 can be implemented as a hash table where the information associated with a transceiver and an override profile serve as the key and value, respectively, for the hash table. In some such other embodiments, override profile manager 110 makes such a determination by performing a lookup on the hash table based on the information associated with the transceiver. One of ordinary skill in the art will appreciate that different techniques may be used to implement match rules storage 130 in different embodiments. If such a match rule exists, override profile manager 110 identifies the override profile specified in the match rule and sends OS 105 a message indicating to use the set of capabilities specified in the identified override profile for the transceiver. If no match rule exists, override profile manager 110 sends OS 105 a message indicating that no override capabilities exist for the transceiver.

Override profile manager 110 also handles requests for determining whether a transceiver matches a particular override profile. For instance, override profile manager 110 can receive from OS 105 a reference to a match rule, information associated with a transceiver, and a request to check whether the transceiver satisfies the match rule. In response to the request, override profile manager 110 uses the reference to the match rule to retrieve the match rule from match rules storage 130. Then, override profile manager 110 determines, based on the information associated with the transceiver, whether the set of matching criteria specified in the match rule are satisfied. If the set of matching criteria specified in the match rule are satisfied, override profile manager 110 identifies the override profile specified in the match rule and sends OS 105 a message indicating to use the set of capabilities specified in the identified override profile for the transceiver. If the set of matching criteria specified in the match rule are not satisfied, override profile manager 110 sends OS 105 a message indicating the transceiver does not satisfy the match rule.

User-defined override profile manager 115 is configured to manage user-defined override profiles for network device 100. For example, during the boot up of network device 100, user-defined override profile manager 115 can receive from OS 105 a set of user-defined override profiles and a set of match rules associated with the set of user-defined override profiles. Once user-defined override profile manager 115 receives this data, user-defined override profile manager 115 sends them to override profile manager 110. In some instances, user-defined override profile manager 115 may receive from OS 105 a user-defined override profile and a match rule associated with the user-defined override profile that are newly received by network device 100. User-defined override profile manager 115 sends this newly received data to override profile manager 110. In other instances, user-defined override profile manager 115 can receive from OS 105 a notification indicating that a user-defined override profile and associated match rule have been deleted. In response to such a notification, user-defined override profile manager 115 forwards the notification to override profile manager 110.

Each of the transceiver ports 135a-n is a physical port into which a modular transceiver may be inserted. In some embodiments, a transceiver is configured to provide a network interface for communicating (e.g., transmitting, receiving, etc.) data. Types of transceivers that can be plugged (i.e., inserted) into transceiver ports 135a-n include SFF pluggable (SFP) transceivers, SFP+transceivers, quad SFP (QSFP) transceivers, etc.

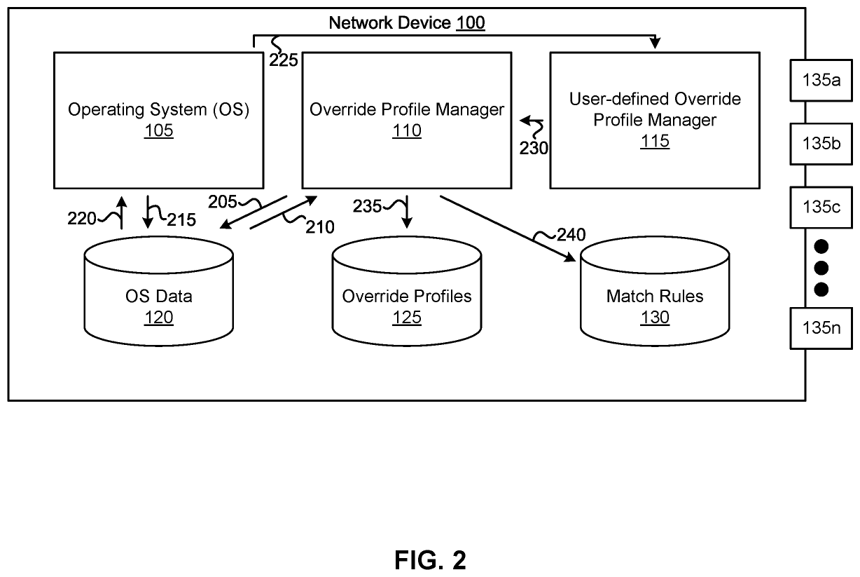

An example operation will now be described by reference to FIG. 2. FIG. 2 illustrates network device 100 preparing override profiles according to some embodiments. In particular, FIG. 2 shows network device 100 preparing override profiles during the boot up of network device 100. For this example, network device 100 has just been powered on and the operation occurs during the boot up process of network device 100. The operation begins by override profile manager 110 accessing, at 205, OS data storage 120 and retrieving, at 210, predefined override profiles and associated match rules from the files that contain them. In addition, OS 105 accesses, at 215, OS data storage 120 to retrieve, at 220, user-defined override profiles and associated match rules persisted in OS data storage 120. Next, OS 105 sends, at 225, the retrieved user-defined override profiles and match rules to user-defined override profile manager 115. Upon receiving the data, user-defined override profile manager 115 sends, at 230, its user-defined override profiles to override profile manager 110. Then, override profile manager 110 stores, at 235, the predefined override profiles and the user-defined override profiles in override profiles storage 125. Lastly, override profile manager 110 stores, at 240, the match rules associated with the predefined override profiles and the match rules associated with the user-defined override profiles in match rules storage 130.

After the boot up process of network device 100 is completed, network device 100 may receive new user-defined override rules and associated match rules. When network device 100 receives a new user-defined override rule and a match rule associated with the user-defined override rule, OS 105 stores them in OS data storage 120. Additionally, OS 105 sends the new user-defined override rule and associated match rule to user-defined override profile manager 115, which forwards them to override profile manager 110. Upon receiving the data, override profile manager 110 stores the new user-defined override profile in override profiles storage 125 and stores the new associated match rule in match rules storage 130. Also after the boot up process of network device 100 is completed, network device 100 can receive (e.g., from a user) a set of instructions to delete a user-defined override profile and associated match rule. In response to the set of instructions, OS 105 deletes them from OS data storage 120. OS 105 then sends a notification indicating that the user-defined override profile and associated match rule have been deleted to user-defined override profile manager 115, which forwards the notification to override profile manager 110. Once override profile manager 110 receives the notification, override profile manager 110 deletes the user-defined override profile from override profiles storage 125 and deletes the associated match rule from match rules storage 130.

After the boot up process of network device 100 is completed, user-defined override profile manager 115 can also receive requests from users to modify existing user-defined override profiles and/or associated match rules. In response to such a request, user-defined override profile manager 115 sends OS 105 a request for the user-defined override profile and/or associated match rule. When OS 105 receives the request from user-defined override profile manager 115, OS 105 retrieves the requested user-defined override profile and/or associated match rule from OS data storage 120 and sends them to user-defined override profile manager 115. Once the user is finished modifying the user-defined override profile and/or associated match rule, user-defined override profile manager 115 sends the modified user-defined override profile and/or associated match rule to OS 105 for OS 105 to update OS data storage 120 with the modified user-defined override profile and/or associated match rule. In addition, user-defined override profile manager 115 sends the modified user-defined override profile and/or associated match rule to override profile manager 110, which updates override profiles storage 125 and/or match rules storage 130 with the modified user-defined override profile and/or associated match rule.

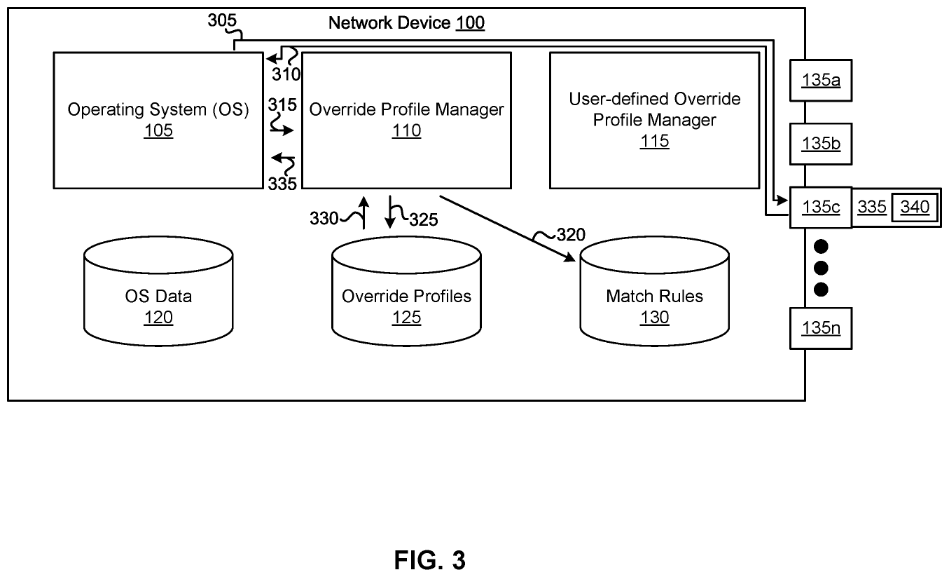

Another example operation will now be described by reference to FIG. 3. FIG. 3 illustrates network device 100 determining capabilities for an inserted transceiver according to some embodiments. In this example, transceiver 335 has just been inserted into transceiver port 135c causing transceiver 335 to be communicatively coupled (e.g., electrically coupled through electrical connections) to network device 100. As shown, transceiver 335 includes memory 340 that stores data that includes information associated with transceiver 335 (e.g., vendor information, firmware information, etc.) and a set of advertised capabilities for transceiver 335. For this example, the information associated with transceiver 335 includes a vendor name “Acme, Inc.” and a transceiver part number “1234567890.”

The operation starts by OS 105 detecting that transceiver 335 has been inserted into transceiver port 135c. In response to the detection, OS 105 accesses, at 305, memory 340 of transceiver 335. Next, OS 105 reads, at 310, the data stored in memory 340 of transceiver 335. OS 105 then sends, at 315, override profile manager 110 a request for a set of override capabilities for transceiver 335 as well as the information associated with transceiver 335 that was read from memory 340 of transceiver 335. Upon receiving the request, override profile manager 110 accesses, at 320, match rules storage 130 and determines, based on the information associated with transceiver 335, whether the set of matching criteria specified in a match rule are satisfied. In this example, the set of matching criteria in a match rule stored in match rules storage 130 specifies a vendor name of “Acme, Inc.” and a transceiver part number of “1234567890.” As such, override profile manager 110 determines that the set of matching criteria specified in this match rule are satisfied based on the information associated with transceiver 335.

After finding a match rule that matches transceiver 335, override profile manager 110 then identifies the override profile specified in the match rule. Next, override profile manager 110 accesses, at 325, override profiles storage 125 to retrieve, at 330, the identified override profile. Override profile manager 110 then sends, at 335, OS 105 a message indicating to use the set of capabilities specified in the identified override profile for transceiver 335. Once OS 105 receives message, OS 105 proceeds to control how transceiver 335 operates based on the set of capabilities.

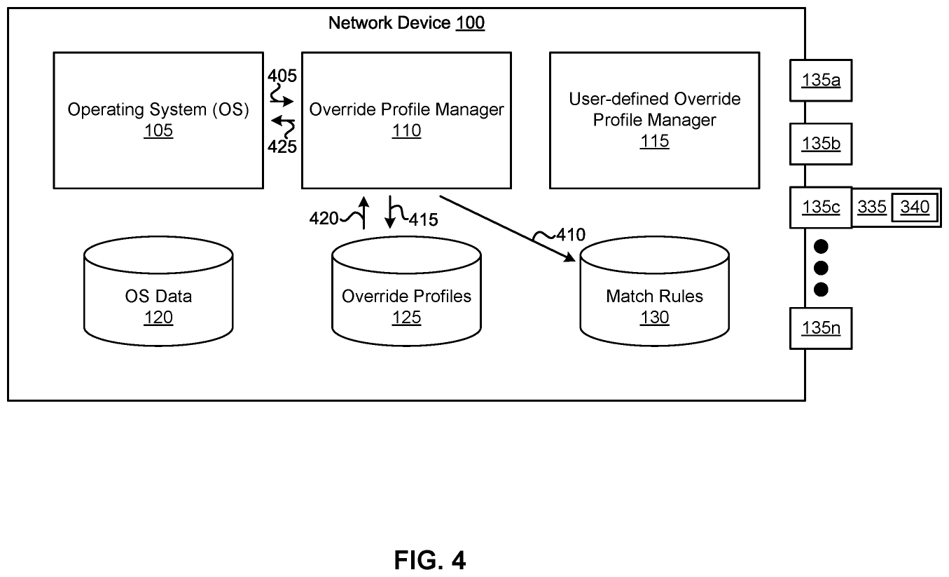

Yet another example operation will now be described by reference to FIG. 4. FIG. 4 illustrates network device 100 processing a new user-defined override profile according to some embodiments. In this example, network device 100 has received a new user-defined override profile and match rule associated with the user-defined override profile from a user (e.g., via a CLI provided by network device 100). In response, OS 105 persisted the user-defined override profile and the associated match rule in OS data storage 120. In addition, OS 105 sent the newly received user-defined override profile and associated match rule to user-defined override profile manager 115, which forwarded them to override profile manager 110. Override profile manager 110 stored the user-defined override profile in override profiles storage 125 and stored the associated match rule in match rules storage 130. Then, override profile manager 110 sent OS 105 a notification that override profiles storage 125 and match rules storage 130 have been updated with the newly added user-defined override profile and associated match rule.

Now, the example begins by OS 105 checking each transceiver attached to network device 100 to see if the transceiver matches the set of matching criteria of the match rule. For this example, OS 105 determines that only transceiver port 135c has a transceiver attached to it. To check to see whether transceiver 335 matches the set of matching criteria of the new match rule, OS 105 sends, at 405, override profile manager 110 a reference to the new match rule, information associated with transceiver 335, and a request to check whether the transceiver satisfies the match rule. In response to the request, override profile manager 110 uses the reference to the match rule to retrieve, at 410, the match rule from match rules storage 130. Override profile manager 110 then determines, based on the information associated with transceiver 335, whether the set of matching criteria specified in the match rule are satisfied. Here, the set of matching criteria specified in the match rule are satisfied. Thus, override profile manager 110 accesses, at 415, override profiles storage 125 and retrieves, at 420, the override profile specified in the match rule. Finally, override profile manager 110 sends, at 425, OS 105 a message indicating to use the set of capabilities specified in the identified override profile for transceiver 335. Upon receiving the message from override profile manager 110, OS 105 starts using the set of override capabilities for transceiver 335.

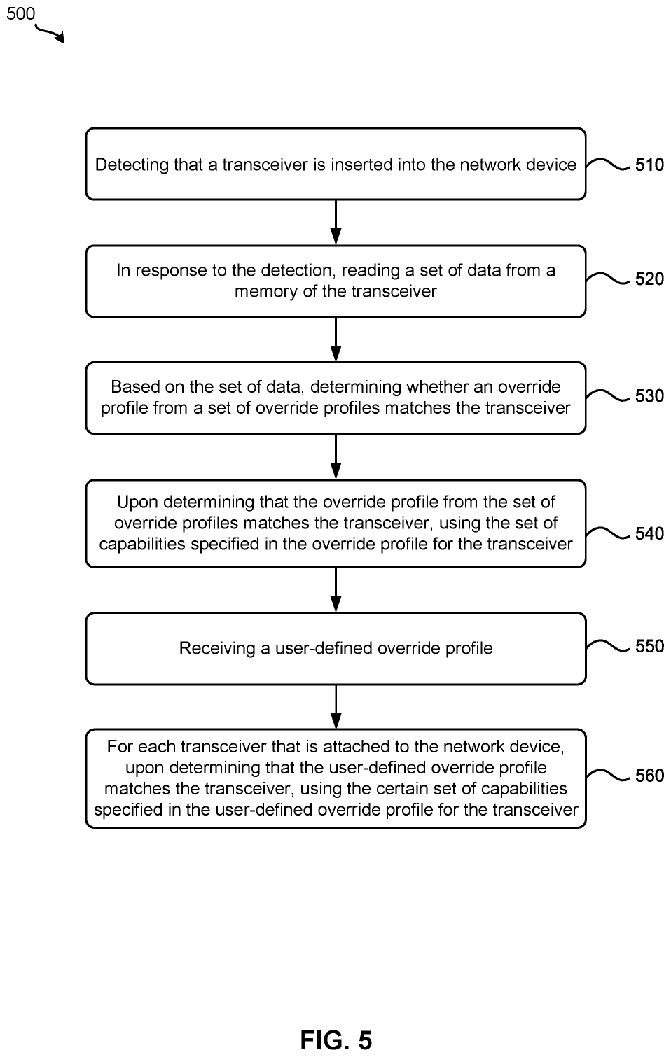

FIG. 5 illustrates a process 500 for determining capabilities for an inserted transceiver according to some embodiments. In some embodiments, network device 100 performs process 500. Process 500 begins by detecting, at 510, that a transceiver is inserted into the network device. Referring to FIG. 3 as an example, OS 105 can detect that transceiver 335 is inserted into transceiver port 135c of network device 100.

Next, in response to the detection, process 500 reads, at 520, a set of data from a memory of the transceiver. Referring to FIG. 3 as an example, OS 105 may read a set of data from memory 340 of transceiver 335. As explained above, the set of data includes information associated with transceiver 335 and a set of advertised capabilities for transceiver 335.

Based on the set of data, process 500 then determines, at 530, whether an override profile from a set of override profiles matches the transceiver. Each override profile in the set of override profiles specifies a set of capabilities to be used for a particular transceiver. Referring to FIG. 3 as an example, override profile manager 110 determines whether an override profile from a set of override profiles matches the transceiver by determining whether the set of matching criteria specified in a match rule are satisfied based on the information associated with transceiver 335.

Upon determining that the override profile from the set of override profiles matches the transceiver, process 500 uses, at 540, the set of capabilities specified in the override profile for the transceiver. Referring to FIG. 3 as an example, override profile manager 110 may determine that a match rule matches transceiver 335. In response, override profile manager 110 identifies the override profile specified in the match rule and sends OS 105 a message indicating to use the set of capabilities specified in the identified override profile for transceiver 335. In response to the message, OS 105 proceeds to control how transceiver 335 operates based on the set of capabilities.

At 550, process 500 receives a user-defined override profile. Referring to FIG. 4 as an example, network device 100 can receive a new user-defined override profile and match rule associated with the user-defined override profile from a user.

Finally, for each transceiver that is attached to the network device, upon determining that the user-defined override profile matches the transceiver, process 500 uses, at 560, the certain set of capabilities specified in the user-defined override profile for the transceiver. Referring to FIG. 4 as an example, OS 105 may check each transceiver attached to network device 100 to see if the transceiver matches the set of matching criteria of the match rule. For the example shown in FIG. 4, OS 105 determines that only transceiver port 135c has a transceiver attached to it. OS 105 checks whether transceiver 335 matches the set of matching criteria of the new match rule by sending override profile manager 110 a reference to the new match rule, information associated with transceiver 335, and a request to check whether the transceiver satisfies the match rule. In response to the request, override profile manager 110 uses the reference to the match rule to retrieve the match rule from match rules storage 130. Next, override profile manager 110 determines, based on the information associated with transceiver 335, whether the set of matching criteria specified in the match rule are satisfied. In this example, the set of matching criteria specified in the match rule are satisfied so override profile manager 110 accesses override profiles storage 125 and retrieves the override profile specified in the match rule. Then, override profile manager 110 sends OS 105 a message indicating to use the set of capabilities specified in the identified override profile for transceiver 335. In response, OS 105 starts using the set of override capabilities for transceiver 335

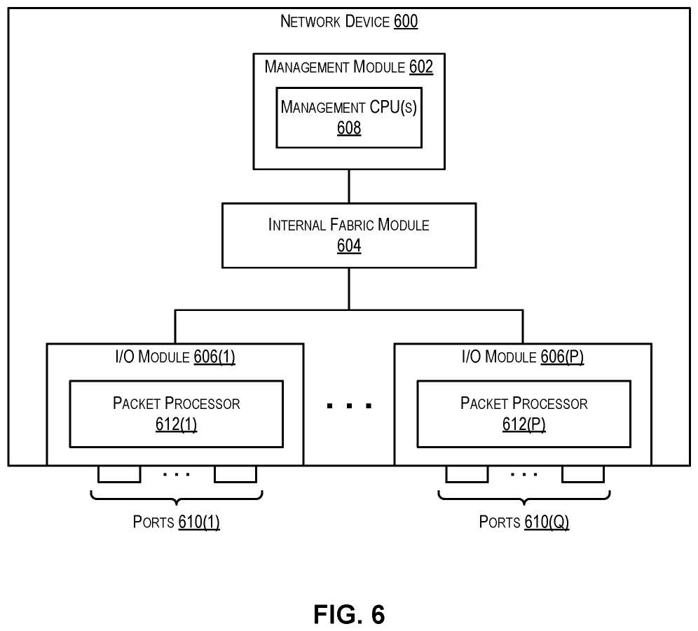

FIG. 6 illustrates the architecture of an example network device (e.g., a network switch or router) 600 that may implement the techniques of the present disclosure according to certain embodiments. For example, network device 600 may be used to implement network device 100 shown in FIGS. 1-3.

Network device 600 includes a management module 602, an internal fabric module 604, and a number of I/O modules 606(1)-(P). Management module 602 includes one or more management CPUs 608 for managing/controlling the operation of the device. Each management CPU 608 can be a general-purpose processor, such as an Intel/AMD x86 or ARM-based processor, that operates under the control of program code maintained in an associated volatile memory and/or stored in a non-transitory computer readable storage medium (not shown). In one set of embodiments, this program code can include code for implementing some or all of the techniques described in the foregoing sections.

Internal fabric module 604 and I/O modules 606(1)-(P) collectively represent the data, or forwarding, plane of network device 600. Internal fabric module 604 is configured to interconnect the various other modules of network device 600. Each I/O module 606 includes one or more input/output ports 610(1)-(Q) that are used by network device 600 to send and receive network packets. Each I/O module 606 can also include a packet processor 612, which is a hardware processing component that can make wire speed decisions on how to handle incoming or outgoing network packets.

It should be appreciated that network device 600 is illustrative and other configurations having more or fewer components than network device 600 are possible.

The following are some example embodiments of the present disclosure. In some embodiments, the techniques described herein relate to a method for managing transceiver capabilities for a network device. The method comprising detecting that a transceiver is inserted into the network device; in response to the detection, reading a set of data from a memory of the transceiver; based on the set of data, determining whether an override profile from a set of override profiles matches the transceiver, wherein each override profile in the set of override profiles specifies a set of capabilities to be used for a particular transceiver; and upon determining that the override profile from the set of override profiles matches the transceiver, using the set of capabilities specified in the override profile for the transceiver

In some embodiments, the techniques described herein relate to a method, wherein a set of match rules are stored on the network device, wherein each match rule in the set of match rules specifies a set of matching criteria and an override profile in the set of override profiles to use when the set of matching criteria are satisfied, wherein determining whether the override profile from the set of override profiles matches the transceiver comprises iterating through the set of match rules stored on the network device to check whether the set of matching criteria of each match rule in the set of match rules is satisfied by the set of data read from the memory of the transceiver and determining that a particular set of matching criteria specified in a particular match rule in the set of match rules satisfied by the set of data read from the memory of the transceiver, wherein the particular match rule specifies the override profile.

In some embodiments, the techniques described herein relate to a method, wherein the set of matching criteria specified in the override profile comprises vendor information or firmware information.

In some embodiments, the techniques described herein relate to a method further comprising receiving a user-defined override profile, wherein the user-defined override profile specifies a certain set of capabilities to be used for a certain transceiver and, for each transceiver that is attached to the network device, upon determining that the user-defined override profile matches the transceiver, using the certain set of capabilities specified in the user-defined override profile for the transceiver.

In some embodiments, the techniques described herein relate to a method, wherein the override profile is a predefined override profile stored in a set of prepackaged files provided with an operating system configured to execute on the network device.

In some embodiments, the techniques described herein relate to a method, wherein the override profile is a user-defined override profile received through a command line interface provided by the network device.

In some embodiments, the techniques described herein relate to a method, wherein the set of capabilities specified in the override profile comprises a capability that is not specified in the memory of the transceiver.

In some embodiments, the techniques described herein relate to a method, wherein the set of data specifies an advertised set of capabilities, the method further comprising, upon determining that the override profile from the set of override profiles does not match the transceiver, using the advertised set of capabilities for the transceiver.

In some embodiments, the techniques described herein relate to a method, wherein a capability in the set of capabilities comprises a feature, function, or parameter that is specific to a particular standard.

In some embodiments, the techniques described herein relate to a method, wherein a capability in the set of capabilities comprises a feature, function, or parameter that is not advertised by the transceiver.

In some embodiments, the techniques described herein relate to a non-transitory machine-readable medium storing a program executable by a network device. The program comprising sets of instructions for detecting that a transceiver is inserted into the network device; in response to the detection, reading a set of data from a memory of the transceiver; based on the set of data, determining whether an override profile from a set of override profiles matches the transceiver, wherein each override profile in the set of override profiles specifies a set of capabilities to be used for a particular transceiver; and upon determining that the override profile from the set of override profiles matches the transceiver, instructing an operating system running on the network device to control how the transceiver operates based on the set of capabilities specified in the override profile.

In some embodiments, the techniques described herein relate to a non-transitory machine-readable medium, wherein a set of match rules are stored on the network device, wherein each match rule in the set of match rules specifies a set of matching criteria and an override profile in the set of override profiles to use when the set of matching criteria are satisfied, wherein determining whether the override profile from the set of override profiles matches the transceiver comprises iterating through the set of match rules stored on the network device to check whether the set of matching criteria of each match rule in the set of match rules is satisfied by the set of data read from the memory of the transceiver and determining that a particular set of matching criteria specified in a particular match rule in the set of match rules satisfied by the set of data read from the memory of the transceiver, wherein the particular match rule specifies the override profile.

In some embodiments, the techniques described herein relate to a non-transitory machine-readable medium, wherein the set of matching criteria specified in the override profile comprises vendor information or firmware information.

In some embodiments, the techniques described herein relate to a non-transitory machine-readable medium, wherein the program further comprises sets of instructions for receiving a user-defined override profile, wherein the user-defined override profile specifies a certain set of capabilities to be used for a certain transceiver and, for each transceiver that is attached to the network device, upon determining that the user-defined override profile matches the transceiver, using the certain set of capabilities specified in the user-defined override profile for the transceiver.

In some embodiments, the techniques described herein relate to a non-transitory machine-readable medium, wherein the override profile is a predefined override profile stored in a set of prepackaged files provided with an operating system configured to execute on the network device.

In some embodiments, the techniques described herein relate to a non-transitory machine-readable medium, wherein the override profile is a user-defined override profile received through a command line interface provided by the network device.

In some embodiments, the techniques described herein relate to a non-transitory machine-readable medium, wherein the set of capabilities specified in the override profile comprises a capability that is not specified in the memory of the transceiver.

In some embodiments, the techniques described herein relate to a non-transitory machine-readable medium, wherein the set of data specifies an advertised set of capabilities, the method further comprising, upon determining that the override profile from the set of override profiles does not match the transceiver, using the advertised set of capabilities for the transceiver.

In some embodiments, the techniques described herein relate to a non-transitory machine-readable medium, wherein a capability in the set of capabilities comprises a feature, function, or parameter that is specific to a particular standard.

In some embodiments, the techniques described herein relate to a network device comprising a set of processing units and a non-transitory machine-readable medium storing instructions that when executed by at least one processing unit in the set of processing units cause the at least one processing unit to, upon detecting that a transceiver is inserted into the network device, read a set of data from a memory of the transceiver; based on the set of data, determine whether an override profile from a set of override profiles matches the transceiver, wherein each override profile in the set of override profiles specifies a set of capabilities to be used for a particular transceiver; and upon determining that the override profile from the set of override profiles matches the transceiver, control behaviors of the transceiver based on the set of capabilities specified in the override profile.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

What is claimed is:

1. A method for managing transceiver capabilities for a network device, the method comprising:
detecting that a transceiver is inserted into the network device;
in response to the detection, reading a set of data from a memory of the transceiver;
based on the set of data, determining whether an override profile from a set of override profiles matches the transceiver, wherein each override profile in the set of override profiles specifies a set of capabilities to be used for a particular transceiver; and
upon determining that the override profile from the set of override profiles matches the transceiver, using the set of capabilities specified in the override profile for the transceiver.

2. The method of claim 1, wherein a set of match rules are stored on the network device, wherein each match rule in the set of match rules specifies a set of matching criteria and an override profile in the set of override profiles to use when the set of matching criteria are satisfied, wherein determining whether the override profile from the set of override profiles matches the transceiver comprises:
iterating through at least a subset of the set of match rules stored on the network device to check whether the set of matching criteria of each match rule in the set of match rules is satisfied by the set of data read from the memory of the transceiver; and
determining that a particular set of matching criteria specified in a particular match rule in the set of match rules satisfied by the set of data read from the memory of the transceiver, wherein the particular match rule specifies the override profile.

3. The method of claim 1, wherein the set of matching criteria specified in the override profile comprises vendor information or firmware information.

4. The method of claim 1 further comprising:
receiving a user-defined override profile, wherein the user-defined override profile specifies a certain set of capabilities to be used for a certain transceiver; and
for each transceiver that is attached to the network device, upon determining that the user-defined override profile matches the transceiver, using the certain set of capabilities specified in the user-defined override profile for the transceiver.

5. The method of claim 1, wherein the override profile is a predefined override profile stored in a set of prepackaged files provided with an operating system configured to execute on the network device.

6. The method of claim 1, wherein the override profile is a user-defined override profile received through a command line interface provided by the network device.

7. The method of claim 1, wherein the set of capabilities specified in the override profile comprises a capability that is not specified in the memory of the transceiver.

8. The method of claim 1, wherein the set of data specifies an advertised set of capabilities, the method further comprising, upon determining that the override profile from the set of override profiles does not match the transceiver, using the advertised set of capabilities for the transceiver.

9. The method of claim 1, wherein a capability in the set of capabilities comprises a feature, function, or parameter that is specific to a particular standard.

10. The method of claim 1, wherein a capability in the set of capabilities comprises a feature, function, or parameter that is not advertised by the transceiver.

11. A non-transitory machine-readable medium storing a program executable by a network device, the program comprising sets of instructions for:
detecting that a transceiver is inserted into the network device;
in response to the detection, reading a set of data from a memory of the transceiver;
based on the set of data, determining whether an override profile from a set of override profiles matches the transceiver, wherein each override profile in the set of override profiles specifies a set of capabilities to be used for a particular transceiver; and
upon determining that the override profile from the set of override profiles matches the transceiver, instructing an operating system running on the network device to control how the transceiver operates based on the set of capabilities specified in the override profile.

12. The non-transitory machine-readable medium of claim 11, wherein a set of match rules are stored on the network device, wherein each match rule in the set of match rules specifies a set of matching criteria and an override profile in the set of override profiles to use when the set of matching criteria are satisfied, wherein determining whether the override profile from the set of override profiles matches the transceiver comprises:
iterating through the set of match rules stored on the network device to check whether the set of matching criteria of each match rule in the set of match rules is satisfied by the set of data read from the memory of the transceiver; and
determining that a particular set of matching criteria specified in a particular match rule in the set of match rules satisfied by the set of data read from the memory of the transceiver, wherein the particular match rule specifies the override profile.

13. The non-transitory machine-readable medium of claim 11, wherein the set of matching criteria specified in the override profile comprises vendor information or firmware information.

14. The non-transitory machine-readable medium of claim 11, wherein the program further comprises sets of instructions for:
receiving a user-defined override profile, wherein the user-defined override profile specifies a certain set of capabilities to be used for a certain transceiver; and
for each transceiver that is attached to the network device, upon determining that the user-defined override profile matches the transceiver, using the certain set of capabilities specified in the user-defined override profile for the transceiver.

15. The non-transitory machine-readable medium of claim 11, wherein the override profile is a predefined override profile stored in a set of prepackaged files provided with an operating system configured to execute on the network device.

16. The non-transitory machine-readable medium of claim 11, wherein the override profile is a user-defined override profile received through a command line interface provided by the network device.

17. The non-transitory machine-readable medium of claim 11, wherein the set of capabilities specified in the override profile comprises a capability that is not specified in the memory of the transceiver.

18. The non-transitory machine-readable medium of claim 11, wherein the set of data specifies an advertised set of capabilities, the method further comprising, upon determining that the override profile from the set of override profiles does not match the transceiver, using the advertised set of capabilities for the transceiver.

19. The non-transitory machine-readable medium of claim 11, wherein a capability in the set of capabilities comprises a feature, function, or parameter that is specific to a particular standard.

20. A network device comprising:
a set of processing units; and
a non-transitory machine-readable medium storing instructions that when executed by at least one processing unit in the set of processing units cause the at least one processing unit to:
upon detecting that a transceiver is inserted into the network device, read a set of data from a memory of the transceiver;
based on the set of data, determine whether an override profile from a set of override profiles matches the transceiver, wherein each override profile in the set of override profiles specifies a set of capabilities to be used for a particular transceiver; and
upon determining that the override profile from the set of override profiles matches the transceiver, control behaviors of the transceiver based on the set of capabilities specified in the override profile.
